(19) United States
(12) Patent Application Publication
(10) Pub. No.: US 2006/0056754 A1
(43) Pub. Date: Mar. 16, 2006

(54) Machine element for rolling loads

(75) Inventors: Oskar Beer, Landshut (DE); Franz-Josef Ebert, Hammelburg (DE); Gerhard Kreiselmeier, Dittelbrunn (DE); Edgar Streit, Poppenlauer (DE)

Correspondence Address: OSTROLENK FABER GERB & SOFFEN, 1180 AVENUE OF THE AMERICAS, NEW YORK, NY, 100368403, US

(73) Assignee: FAG Kugelfischer AG

(21) Appl. No.: 11/196,152

(22) Filed: Aug. 3, 2005

Related U.S. Application Data
(60) Provisional application No. 60/598,892, filed on Aug. 4, 2004.

(51) Int. Cl. F16C 33/00

(52) U.S. Cl. 384/625

(57) ABSTRACT

A machine element of steel with a martensitic microstructure and which at least in a load-free state, has thermochemically produced residual compressive stresses in the microstructure under at least a portion of the surface of the machine element, down to a depth from the surface of the element. The stresses are in an outer layer of the element which may be treated specially. The element may be one element of a rolling bearing.

### CROSS REFERENCE TO RELATED APPLICATION

This application is based upon and claims benefit of U.S. Provisional Application 60/598,892, filed on Aug. 4, 2004, to which a claim of priority is hereby made.

### FIELD OF THE INVENTION

The invention relates to a machine element which is formed from a steel with a martensitic microstructure and which, at least in a load-free state, has residual compressive stresses in the microstructure under at least a portion of the surface of the machine element.

### BACKGROUND OF THE INVENTION

Machine elements of this type are described in US 2004/0071379 A1. In particular, when they are in sliding/rolling contact with a further machine element, the machine elements are sensitive to dirt particles, for example in the lubricant of a bearing. The dirt particles which are subjected to rolling load in the rolling contact initially cause indentations and bumps in the surface of the machine elements and/or the machine element in question and ultimately lead to failure of a system including the machine elements, for example of a roller bearing.

As is also described in US 2004/0071379 A1, the sensitivity of the surfaces of machine elements of this type is dependent on the nature and magnitude of the stresses prevailing at and below the surface (in the outer layer) of the machine element. In this context, the term nature is to be understood as meaning residual stresses (tensile or compressive stresses) in the outer layer of the machine element or stresses acting on the machine element as a result of external action. Tensile stresses at the surface and in the outer layer below the surface increase the susceptibility of the machine element to failure. Tensile stresses are caused by operating conditions to which the machine element is exposed.

For example, at an inner ring of a roller bearing, the tensile stresses acting on the outer raceway located thereon and at the edges are intensified by the required press fit of the inner ring on a shaft. If this inner ring additionally rotates at high speeds, the tensile stresses may reach a level at which the susceptibility of the inner ring to failure, e.g. during operation in the mixed friction range, in the presence of soiling, etc., is significantly increased, and therefore the useful life and the reliability of the bearing are significantly reduced.

It is also conceivable that in the load-free machine element, residual compressive stresses will initially be present in the outer region, but on account of superimposed high tensile stresses from loads, such as press-fit connections or centrifugal forces, these residual compressive stresses will disadvantageously migrate toward tensile stresses.

The person skilled in the art therefore aims to produce residual stresses in the load-free machine element as compressive stresses (stresses indicated as negative, i.e. bearing the sign (−)) by means of mechanical or thermochemical treatment. If the mechanical route is used, compressive stresses of this type are produced, for example, by shot peening. Shot peening compacts the microstructure at the surface of the machine element and thereby produces residual compressive stresses. However, a process of this type is only suitable for producing compressive stresses in outer layers with a low depth. If it were desired to use a mechanical process of this type to produce deeper outer layers with residual compressive stresses, the intensity with which these layers would have to be blasted would produce incipient damage or fatigue at the surface and would reduce the rolling resistance of the machine element and therefore the service life which can be achieved.

Therefore, US 2004/0071379 provides a thermochemical process (nitriding), in which the deeper regions of the outer layer, at between 100 μm and 700 μm below the surface, have residual compressive stresses, the level of which is so high that even under operating conditions they cannot migrate to become the disadvantageous tensile stresses. However, a drawback of this solution is that the residual compressive stresses in the outer zone just below the surface are, however, very low, on account of undesirably high levels of inclusions and subsequent material-removing machining. Machine elements which have been treated in this manner, as before, are still prone to the risk of the compressive stresses, in the event of additional loads on the machine element resulting from operating conditions, being overridden or compensated for by tensile stresses, which have a disadvantageous effect, as a result of tensile stresses resulting from a press-fit connection and possibly also as a result of centrifugal forces.

### SUMMARY OF THE INVENTION

Therefore, the object of the invention is to provide a machine element for sliding and/or rolling loads which avoids the above-mentioned drawbacks.

According to the invention, this object is achieved by forming the machine element from a steel with a martensitic microstructure, which in a load-free state has thermochemically produced residual compressive stresses beneath at least a portion of the surface of the machine element. The level of the residual compressive stresses is at least −300 MPa or below, i.e. for example −1000 MPa or even lower, for example −1200 MPa, down to a depth of <μ40 m. Accordingly, the compressive stress in positive terms, expressed as an absolute value (in accordance with the mathematical definition of the term value) is at least 300 MPa or more, for example 1200 MPa, at a depth down to 40 μm.

The machine part is load-free if, produced as a finished component, it is, at least at the portion with the compressive stresses below the surface, still not exposed to any loads which alter or are superimposed on the nature and magnitude of the residual compressive stresses in accordance with the invention. The loads may be of kinematic or mechanical nature. Loads of this type result, for example, from the machine part being installed in the surrounding structure, for example loads from a press fit. Other loads are those to which the component is exposed in operation, such as for example centrifugal forces from rotation or pressures resulting from punctiform, linear or areal touching in sliding or rolling contact with other machine elements. Further examples of such loads include notch effects, bending, tension and compression.

The compressive stresses are formed at least in a portion below the surface of the machine element which is intended for sliding and/or rolling pairing with at least one further rolling part. According to the invention, these residual compressive stresses in the microstructure of the steel are not produced mechanically, but rather by means of a thermochemical heat treatment process in the outer layer. The entire surface, or just a portion of the machine element according to the invention, are therefore relatively insensitive to high surface pressures and/or notch effects, even close to the surface, on account of the values which have been set. Examples of portions at surfaces of machine elements include the outer zones of the rolling raceways on bearing rings of a roller bearing or the outer zones at the bearing rings which are intended for radial guidance of a cage. Another example is the flanks of gearwheels which are in meshing rolling or alternatively partially rolling/sliding contact with in each case one further tooth flank. One example of a machine element which has the residual compressive stresses according to the invention formed beneath its entire surface is the ball as a rolling body in a roller bearing.

One configuration of the invention provides for the residual compressive stresses to be formed in a fully machined outer layer of the machine element. The term fully machined outer layer is to be understood as meaning, for example, the finish-ground and if appropriate honed raceway of a roller bearing or a surface of a rolling body which has been machined in this manner, for example the surface of a ball or a roll or such as the fully ground flanks of a gearwheel, or such as the raceways of a ball screw which has been machined in this or some similar way. The residual compressive stresses are formed, for example, in a nitrogen-enriched outer layer. This outer layer is produced by gas nitriding and preferably by plasma nitriding.

In a further configuration of the invention, the starting point is for the outer layer to be produced by what is known as double (duplex) hardening, i.e. first of all the steel is hardened, and then it is subjected to a further thermochemical heat treatment, in which the outer layer is formed. The hardening process is the standard process known to the person skilled in the art, in which the steel is austenitized, quenched and tempered. Therefore, the first heat treatment, which is characterized by known hardening and includes a tempering operation, is followed by a second heat treatment, which produces the compressive stresses in accordance with the invention. It is provided that the steel is a high-temperature steel, the microstructure of which permits a tempering temperature used during the first hardening operation of at least 400° C. Accordingly, the temperature used during the subsequent outer layer hardening is over 400° C., for example for plasma nitriding is in a range from 400° C. to 600° C. The tempering temperature used in the first hardening process is above the temperature which is employed for the nitriding of the outer layer.

Further configurations of the invention provide for the invention to be used for steels having the designations and minimum compositions listed below:

a. having the designation M50 (AMS 6491), comprising
0.8 to 0.85% by weight of C
4 to 4.25% by weight of Cr
4 to 4.5% by weight of Mo
0.15 to 0.35% by weight of Mn
0.1 to 0.25% by weight of Si
0.9 to 1.1% by weight of V
max. 0.015% by weight of P
max. 0.008% by weight of S
and comprising further alloying constituents and iron, as well as standard impurities.

b. having the designation M50NiL (AM6278), comprising:
0.11 to 0.15% by weight of C
4.0 to 4.25% by weight of Cr
4.0 to 4.5% by weight of Mo
1.1 to 1.3% by weight of V
3.2 to 3.6% by weight of Ni
0.15 to 0.35% by weight of Mn
0.1 to 0.25% by weight of Si
max. 0.015% by weight of P
max. 0.008% by weight of S
and comprising further alloying constituents and iron, as well as standard impurities.

c. having the designation 32CD V13 (AMS6481), at least comprising:
0.29 to 0.36% by weight of C
2.8 to 3.3% by weight of Cr
0.7 to 1.2% by weight of Mo
0.15 to 0.35% by weight of V
0.4 to 0.7% by weight of Mn
0.1 to 0.4% by weight of Si
max. 0.025% by weight of P
max. 0.02% by weight of S
and comprising further alloying constituents and iron, as well as standard impurities.

d. having the designation T1 (S 18-0-1), comprising:
0.7 to 0.8% by weight of C
4 to 5% by weight of Cr
17.5 to 18.5% by weight of Wo
1 to 1.5% by weight of V
0 to 0.4% by weight of Mn
0.15 to 0.35% by weight of Si
max. 0.025% by weight of P
max. 0.008% by weight of S
and comprising further alloying constituents and iron, as well as standard impurities.

e. having the designation RBD, comprising:
0.17 to 0.21% by weight of C
2.75 to 3.25% by weight of Cr
9.5 to 10.5% by weight of Wo
0.2 to 0.4% by weight of Mn
0 to 0.35% by weight of Si
0.35 to 0.5% by weight of V
max. 0.015% by weight of P
max. 0.015% by weight of S
and comprising further alloying constituents and iron, as well as standard impurities.

f. having the designation Pyrowear 675 (AMS5930), comprising:
0.06 to 0.08% by weight of C
12.8 to 13.3% by weight of Cr
1.5 to 2.0% by weight of Mo
0.5 to 0.7% by weight of V
2.2 to 2.8% by weight of Ni
4.8 to 5.8% by weight of Co
0.5 to 1.0% by weight of Mn
0.2 to 0.6% by weight of Si
and comprising further alloying constituents and iron, as well as standard impurities.

The invention relates to all machine elements which, in a pairing with a further machine element or in contact with a plurality of rolling parts, are exposed to a sliding and/or rolling load. The rolling load is produced between the rolling parts as a result of the individual rolling parts (machine elements) rolling along one another. Machine elements of this type include, for example, gearwheels which mesh with other gearwheels, and the resulting rolling load in the rolling contact at the flanks includes any sliding components. Alternative parts in a rolling pairing include machine elements of roller bearings, such as inner and outer rings and rolling bodies (balls and rolls). For use in a roller bearing, in particular for use in bearings for the aeronautical and aerospace industries, there is provision for one or more machine elements of the roller bearing to be provided with the compressive stresses according to the invention at least in the regions intended for the rolling contact and/or sliding contact. Parts for sliding pairings include, for example, gearwheels, whose engagement may also produce combinations of rolling and sliding movements, and components of slide bearings.

Alternatively, the pairings may be formed by machine elements which consist of different materials from element to element. For example, it is conceivable for a machine element according to the invention of a roller bearing in the form of an inner ring to be paired with rolling bodies (for example balls) made from suitable ceramic materials, such as Si3N4, or vice versa.

There is also provision for pairings of machine parts which are made from the same material but of which at least one element does have the compressive stresses in accordance with the invention resulting from a thermochemical treatment, and at least one of the elements does not have these compressive stresses.

There is also provision for pairings in which at least two of the machine elements which are paired with one another are configured in accordance with the invention and are made from identical or different steel grades. For example, the invention also applies to a roller bearing in which both at least one of the bearing rings and at least some of the rolling bodies have the residual compressive stresses resulting from a thermochemical treatment. In this case, it is possible for the bearing rings to be made from a steel of the same composition as the steel of the rolling bearings or of a different composition.

Other features and advantages of the present invention will become apparent from the following description of the invention which refers to the accompanying drawings.

The invention is explained in more detail below on the basis of an exemplary embodiment and on the basis of in-house test and calculation results.

### BRIEF DESCRIPTION OF THE DRAWINGS

FIG. 1 shows a diagrammatic and highly simplified illustration of a roller bearing with which the invention is realized.

FIG. 2 shows, in diagram form, the region close to the surface in which the residual compressive stresses in accordance with the invention are formed.

FIG. 3 illustrates measurement and calculation results in diagram form relating to stresses beneath the surface of single-hardened steel of grade M50 by comparison with double-hardened steel of grade M50.

FIG. 4 shows, in diagram form, the hardness curve in the vicinity of the surface for a roller bearing component according to the invention made from double-hardened steel M50.

FIG. 5 illustrates the measurement and calculation results in diagram form relating to stresses beneath the surface of single-hardened steel of grade M50NiL by comparison with double-hardened steel of grade M50NiL.

FIG. 6 shows the hardness curve in the vicinity of the surface for a roller bearing component according to the invention made from double-hardened steel M50NiL.

### DESCRIPTION OF A PREFERRED EMBODIMENT

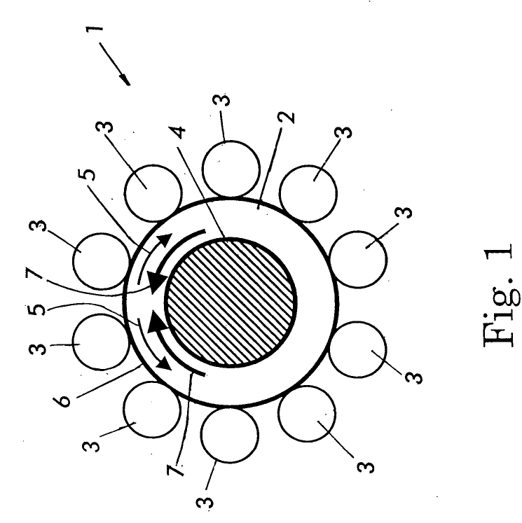

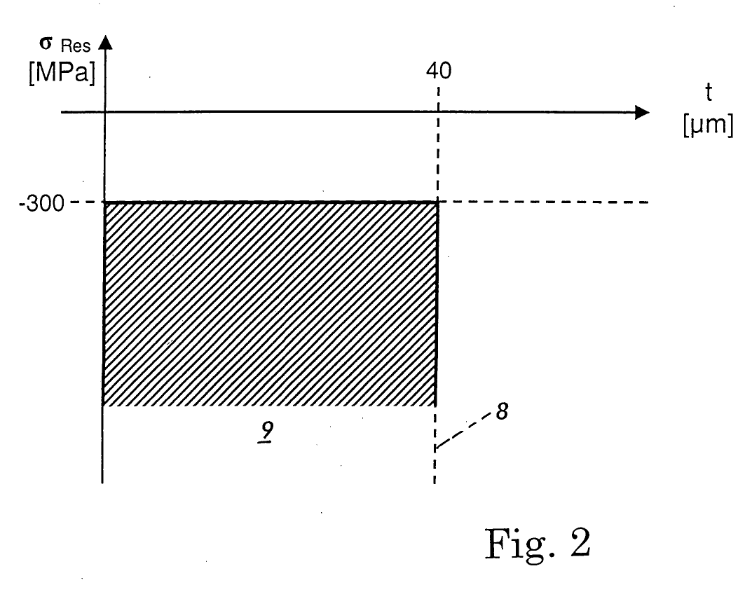

FIG. 1 shows, as an exemplary embodiment of the invention, a roller bearing 1 in which the machine elements according to the invention are an inner ring 2 and/or rolling bodies 3 in the form of balls. The balls are optionally made from the same steel grade as the inner ring 2 or from a different steel grade. The balls and the inner ring 2 are the rolling parts, of which optionally one of the parts or both of the parts has the compressive stresses produced by thermochemical means in accordance with the invention. The inner ring 2 is seated with a press fit on a shaft 4. The shaft 4 rotates at high rotational speeds in the clockwise or counterclockwise direction as desired. The forces from the press fit and the centrifugal forces from the rotation generate tensile stresses 5 (circumferential stresses) in the outer layer 6 of the inner ring 2. At the unfitted ring, the microstructure of the outer layer 6 has residual compressive stresses 7 which are superimposed in opposing fashion on the tensile stresses 5 and compensate for the latter on account of their greater magnitude and their opposite direction of action to the tensile stresses.

FIG. 2 shows the results of the invention in diagram form. The residual compressive stresses σᵣₑₛ in MPa for a load-free outer layer are illustrated as a function of the depth t of the outer layer in μm. The residual compressive stresses σᵣₑₛ prevail at least beneath a portion of the surface of a bearing ring or of a rolling body which is intended for rolling loading. The abscissa of the diagram stands for the outer layer depth t in micrometers. The ordinate in the Figure beneath the abscissa represents the compressive stresses with a negative sign resulting from tension and compression (in megapascals) in the outer layer. The further continuation of the ordinate in the Figure above the abscissa, in the direction indicated by the arrow, represents the tensile stresses with a positive sign, which are inherently disadvantageous. The line 8 marks the distance of 40 μm from the surface, up to which distance the residual compressive stresses σᵣₑₛ have a maximum value of −300 and below. The positive value of the compressive stresses resulting from the value of the residual compressive stresses is accordingly 300 MPa and more, e.g. even 1000 to 1200 MPa.

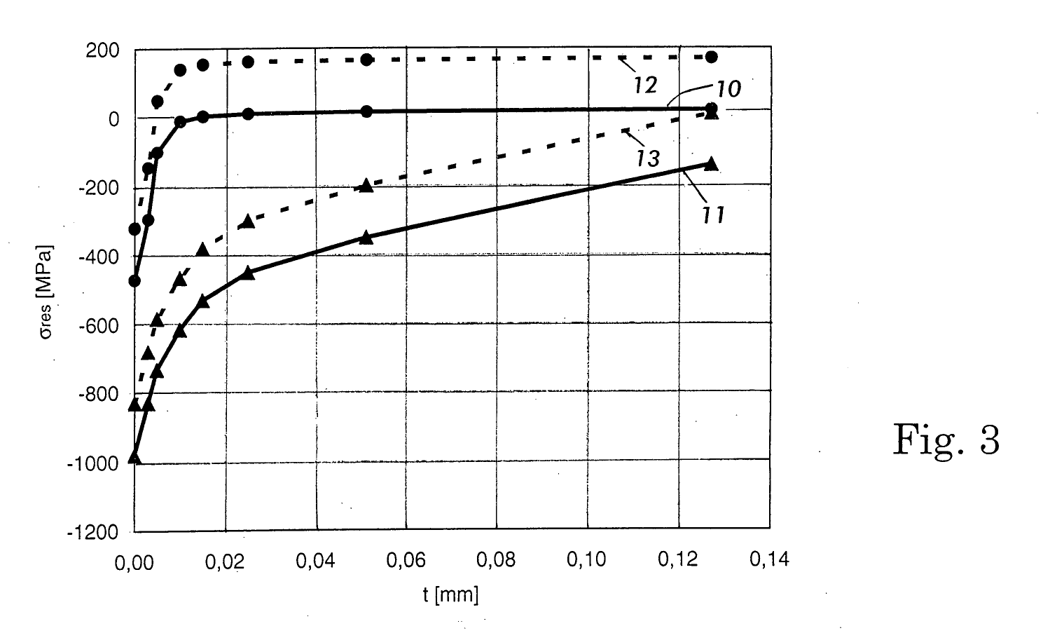

FIG. 3 shows the curve for residual compressive stresses σᵣₑₛ in MPa in an outer layer as a function of the distance t (in μm) from the surface. The abscissa of the diagram also represents the layer depth t, starting from the outer surface, in micrometers, and the ordinate represents the resulting stresses in megapascals in the layer. The area in the Figure above the stresses sres=0 represents the tensile stresses, which are provided with a positive sign and are inherently disadvantageous, while the area below σᵣₑₛ=0 represents the compressive stresses, which are provided with a negative sign.

First of all, lines 10 and 11 compare the curves of the residual stresses in load-free outer layers for roller bearing components made from steel grade M50 without the outer layer which has been modified in accordance with the invention and for a component made from steel grade M50DH. The curves for the load-free states are marked by solid lines for both steel grades. Line 10 shows the curve for the stresses for steel M50, and line 11 shows the curve for steel M50 DH. The letters DH at the end stand for double hardening and indicate a component in which residual compressive stresses have been produced by thermochemical means in the vicinity of the surface in accordance with the invention. This is then followed by a comparison of the curves of the stresses, illustrated by dashed lines 12 and 13, for the same outer layers as those mentioned above, but in this case under load.

In the load-free state, the outer zone of the component made from M50 initially, down to a depth of approx. t=0.08-0.01 mm below the surface, has residual compressive stresses which are approx. −500 MPa at the surface and then move toward zero at 0.08-0.01 mm. As the depth t increases beyond 0.01, to a depth t of 0.12 mm, the line 10 moves in a range in which, apart from a somewhat negligible tendency toward tensile stresses, there are virtually no positive or negative residual stresses.

By contrast, the outer zone of the component made from M50DH has the residual compressive stresses, originating from the thermochemical treatment, in accordance with the invention. The curve of these stresses is illustrated from the value −1000 MPa at the surface to approx. −180 MPa at a depth t of approx. 0.12 mm below the surface, by line 11.

The stress curves for the same components or outer zones, but this time under load, are illustrated by dashed lines 12 and 13 in FIG. 3. Loads on the components are those which cause tensile stresses at least in the outer zone region under consideration. As is described below, these tensile stresses can be superimposed on the residual compressive stresses in such a way that the residual compressive stresses are reduced or compensated for by the operating tensile stresses or are moderately exceeded by the tensile stresses. According to the results illustrated in FIG. 3, the loads are characterized by a shift in the stresses toward the positive stress range of 150 MPa over the entire curve (circumferential stresses of 150 MPa resulting from press fit and centrifugal force).

In the loaded state, the outer zone of the component made from M50 (line 12) initially still has residual compressive stresses of approx. −320 MPa at the surface, but these have been canceled out by tensile stresses at a depth of just 0.003-0.005 mm. At a distance of greater than 0.003 to 0.005 mm from the surface and below, the outer layer has tensile stresses. As the depth t increases from 0.01 down to a depth t of 0.12 mm, the outer zone of the component made from M50 is under threat from virtually constant tensile stresses in the vicinity of +200 Mpa.

In the loaded state, the outer zone of the component made from M50DH with compressive stresses in accordance with the invention (line 13) has residual compressive stresses of approx. −820 MPa at the surface, and these are only canceled out by tensile stresses at a depth of 0.12 mm. On account of the high levels of residual compressive stresses produced by thermochemical treatment at the relevant depth, the outer layer cannot see its residual compressive stresses exceeded by the tensile stresses resulting from loads, and is therefore less at risk.

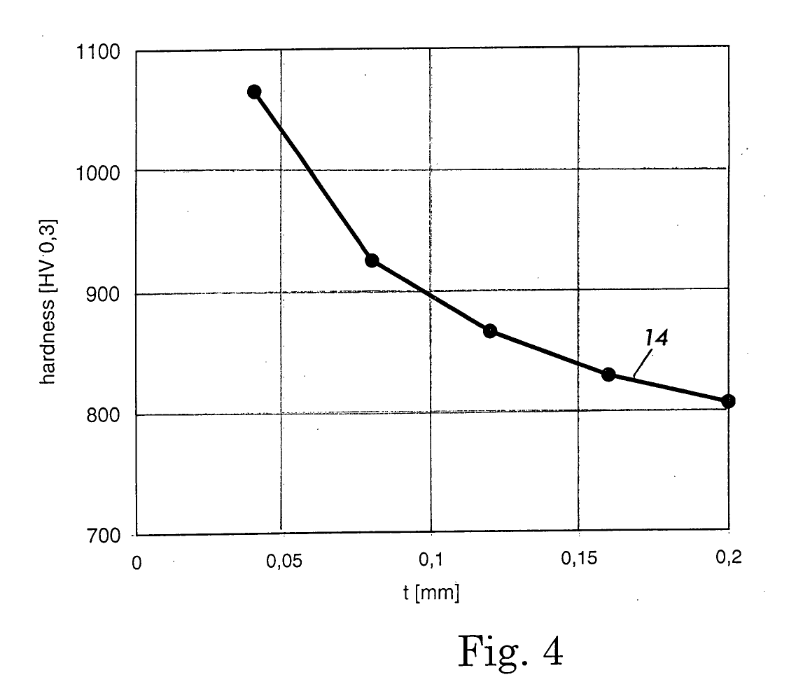

Line 14 in FIG. 4 illustrates the hardness curve in the outer layer of a DH-treated roller bearing component as described in FIG. 3. The outer zone of the component made from M50DH with compressive stresses in accordance with the invention (lines 11 and 13) has a hardness of over 1000 HV0.3 at a depth of 0.05 mm below the surface and of 800 HV0.3 even at a depth of 0.2 mm.

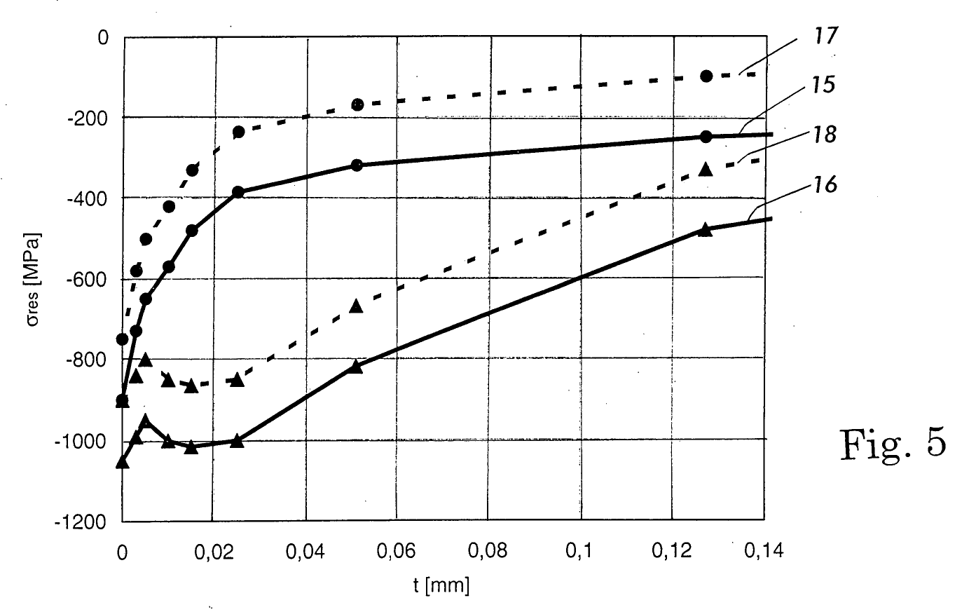

FIG. 5 shows the curve for residual compressive stresses sres in MPa in an outer layer as a function of the distance t (in mm) from the surface. The abscissa of the diagram also represents the layer depth t, starting from the surface, in micrometers, and the ordinate represents the resulting stresses in megapascals in the layer. The area below sres=0 represents the compressive stresses, which are provided with a negative sign.

Lines 15 and 16 compare the curves of the residual stresses of load-free outer layers for roller bearing components made from steel grade M50 NiL, without the outer layer which has been modified in accordance with the invention, and for a component made from steel grade M50 NiLDH. The curves for the load-free states are indicated by solid lines for both steel grades. Line 15 shows the curve for the stresses for steel M50 NiL, and line 16 shows the curve for the steel M50 NiLDH. The letters DH at the end stand for double hardening. This is followed by a comparison of the curves, illustrated by dashed lines 17 and 18, of the stresses in the same outer layers, but under load. Line 17 shows the curve for the stresses for steel M50 NiL, and line 18 shows the curve for steel M50 NiLDH with the outer layer under load.

FIG. 5 describes an exemplary embodiment of the invention in which a material which already had relatively good stress profiles and states in the outer layer was nevertheless improved still further by means of the invention.

In the load-free state and in the loaded state, the outer zone of the component made from M50 NiL has residual compressive stresses beneath the surface. The same is true of the component made from M50 NiLDH. However, the magnitudes of the residual compressive stresses of the component made from M50 NiLDH are significantly higher—at a depth of 0.02 mm below the surface, the difference between the residual compressive stress for the component made from M50 NiLDH (line 18) and the residual compressive stress for the component made from M50 NiL (line 17) is approx. 550 MPa. Therefore, in this case too, the double-hardened component can be subjected to high loads. As the depth of the outer layer increases, this difference drops, but is still over 200 MPa at a depth t of 0.12 mm. As is also the case in the results illustrated in FIG. 3, the loads are characterized by a shift in the stresses toward the positive stress range of 150 MPa over the entire curve (circumferential stresses of 150 MPa resulting from press fit and centrifugal force).

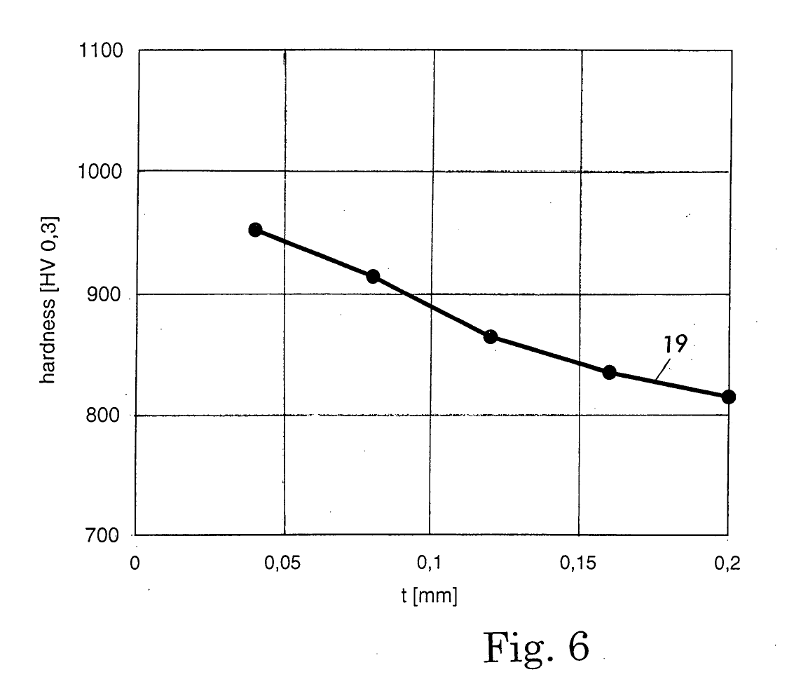

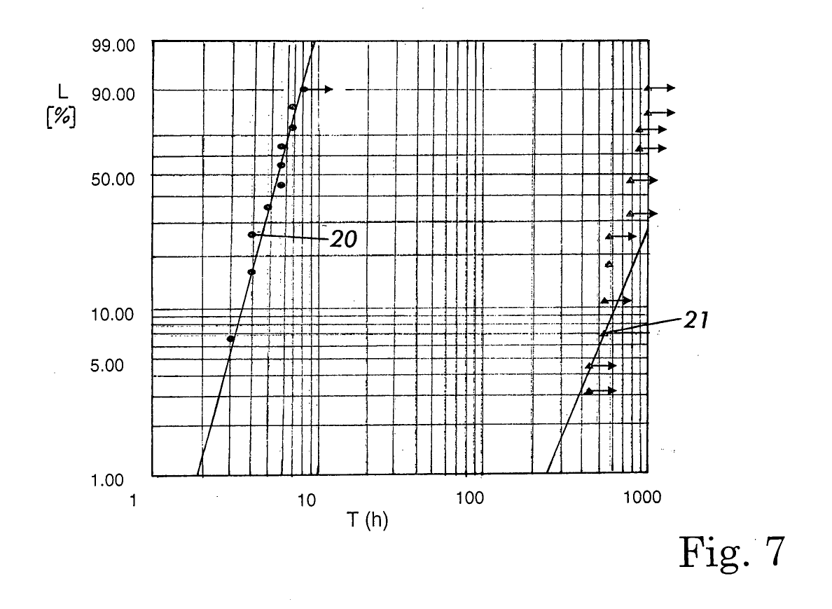

Line 19 in FIG. 6 illustrates the possible curve for the hardness in the outer layer of a roller bearing component according to the invention as has been described, for example, in FIG. 5. The outer zone of the component made from M50 NiLDH with compressive stresses in accordance with the invention (lines 16 and 18) has a hardness of over 900 HV0.3 at a depth of 0.05 mm below the surface and of over 800 HV0.3 even at a depth of 0.2 mm.

FIG. 7 shows a diagram comparing the results 20 of service life tests for a bearing made from M50 and having rolling bodies made from steel, referred to below as a standard bearing, and the results 21 of a hybrid bearing with double-hardened running rings made from M50 DH and having rolling bodies made from ceramic. The measurement results 20 for the standard bearings are illustrated in dot form, while the measurement results 21 for the hybrid bearing are illustrated in the form of triangles. The horizontally directed arrows leading from the measurement results 20, 21 mark the specimens which had still not failed over the course of the running time T used in the diagram.

The test was carried out under the following conditions: axial load 4.1 kN as loading at a temperature of approx. 120° C. in engine oil, which had been highly contaminated through use, for diesel engines at p0.1R of 2300 MPa for the steel balls and at 0.1R of 2600 MPa for the balls made from ceramic. It can be seen that for a failure probability L of 10% (L₁₀), the test specimens of the hybrid bearings according to the invention achieved a running time T in hours which was approximately 180 times or more that of the test specimens from standard bearings.

Although the present invention has been described in relation to a particular embodiment thereof, many other variations and modifications and other uses will become apparent to those skilled in the art. It is preferred, therefore, that the present invention be limited not by the specific disclosure herein, but only by the appended claims.

What is claimed is:

1. A machine element which is formed from a steel with a martensitic microstructure and the element having a surface; at least in a load-free state, and under at least a portion of the surface of the machine element, the element has thermochemically produced residual compressive stresses of a magnitude corresponding to at least an absolute value of −300 MPa from the element surface down into the element to a depth of at most 40 μm.

2. The machine element as claimed in claim 1, which is adapted for at least one rolling pairing at the portion with at least one further machine element.

3. The machine element as claimed in claim 1, the element being fully machined at the surface and having an outer layer below the surface and having the residual compressive stresses in the outer layer of the fully machined machine element.

4. The machine element as claimed in claim 1, wherein the element has an outer layer below the surface and the outer layer is nitrogen-enriched, and the element has the residual compressive stresses in the nitrogen-enriched outer layer.

5. The machine element as claimed in claim 1, wherein the element has an outer layer below the surface and the outer layer is modified by plasma nitriding, and the element has the residual compressive stresses in the outer layer.

6. The machine element as claimed in claim 1, wherein the element has an outer layer below the surface and the outer layer has a microstructure which has been heat-treated twice and the compressive stresses are in the outer layer.

7. The machine element as claimed in claim 1, wherein the steel has a microstructure, which after a first treatment, is suitable for a second heat treatment with a process temperature of at least 400° C.

8. The machine element as claimed in claim 1, made from steel having the designation M50, comprising:
0.8 to 0.85% by weight of carbon
4 to 4.25% by weight of chromium
4 to 4.5% by weight of molybdenum
0.9 to 1.1% by weight of vanadium
0.15 to 0.35% by weight of manganese
0.1 to 0.25% by weight of silicon
max. 0.015% by weight of phosphorus
max. 0.008% by weight of sulfur.

9. The machine element as claimed in claim 1, made from steel with the designation M50NiL, comprising:
0.11 to 0.15% by weight of carbon
4.0 to 4.25% by weight of chromium
4.0 to 4.5% by weight of molybdenum
1.1 to 1.3% by weight of vanadium
3.2 to 3.6% by weight of nickel
0.15 to 0.35% by weight of manganese
0.1 to 0.25% by weight of silicon
max. 0.015% by weight of phosphorus
max. 0.008% by weight of sulfur.

10. The machine element as claimed in claim 1, made from steel having the designation 32CD V13, comprising:
0.29 to 0.36% by weight of carbon
2.8 to 3.3% by weight of chromium
0.7 to 1.2% by weight of molybdenum
0.15 to 0.35% by weight of vanadium
0.4 to 0.7% by weight of manganese
0.1 to 0.4% by weight of silicon
max. 0.025% by weight of phosphorus
max. 0.02% by weight of sulfur.

11. The component as claimed in claim 1, made from steel having the designation T1 (S 18-0-1), comprising:
0.7 to 0.8% by weight of carbon
4 to 5% by weight of chromium
17.5 to 18.5% by weight of tungsten
1 to 1.5% by weight of vanadium
0 to 0.4% by weight of manganese
0.15 to 0.35% by weight of silicon
max. 0.025% by weight of phosphorus
max. 0.008% by weight of sulfur.

12. The component as claimed in claim 1, made from steel having the designation RBD, comprising:
0.17 to 0.21% by weight of carbon
2.75 to 3.25% by weight of chromium
9.5 to 10.5% by weight of tungsten
0.2 to 0.4% by weight of manganese
0 to 0.35% by weight of silicon
0.35 to 0.5% by weight of vanadium
max. 0.015% by weight of phosphorus
max. 0.015% by weight of sulfur.

13. The machine element as claimed in claim 1, made from steel having the designation Pyrowear 675, comprising:
0.06 to 0.08% by weight of carbon
12.8 to 13.3% by weight of chromium
1.5 to 2.0% by weight of molybdenum
0.5 to 0.7% by weight of vanadium
2.2 to 2.8% by weight of nickel
4.8 to 5.8% by weight of cobalt
0.5 to 1.0% by weight of manganese
0.2 to 0.6% by weight of silicon.

14. The machine element as claimed in claim 1, which is shaped as part of a rolling bearing.

15. The machine element as claimed in claim 14, which is shaped as at least one bearing ring in a rolling pairing with rolling bodies.

16. The machine element as claimed in claim 14, which is at least one rolling body in a rolling pairing with at least one bearing ring.

17. The machine element as claimed in claim 1, which is shaped as at least one component of a roller bearing and is in a rolling pairing with at least one other component of the roller bearing, the at least one component being made from a different material than the other of the components and having a different hardness at least at the surface of the one component.
